(19) United States
(12) Patent Application Publication
(10) Pub. No.: US 2016/0348424 A1
(43) Pub. Date: Dec. 1, 2016

(54) FAST ROLL-UP DOOR COMPRISING A CURTAIN HAVING RESILIENT EDGES

(71) Applicant: ASSA ABLOY ENTRANCE SYSTEMS AB, Landskrona (SE)

(72) Inventors: Mauro Lorenzani, Malnate (VA) (IT); Armando Vecchi, Monza (MB) (IT)

(73) Assignee: ASSA ABLOY Entrance Systems AB, Landskrona (SE)

(21) Appl. No.: 15/116,730

(22) PCT Filed: Feb. 10, 2015
(86) PCT No.: PCT/EP2015/052763

§ 371 Date: Aug. 4, 2016

(30) Foreign Application Priority Data
Feb. 12, 2014 (SE) 1450153-0

(51) Int. Cl. E06B 9/15; E06B 9/58

(52) U.S. Cl. CPC E06B 9/15; E06B 9/581; E06B 2009/1505; E06B 2009/1533; E06B 2009/1594

(57) ABSTRACT

The present invention concerns a fast roll-up door for closing an aperture (20), said roll-up door comprising:
(a) a curtain (1) having two opposite and parallel lateral edges extending along a longitudinal direction, and two opposite end edges joining the lateral edges, each of the two lateral edges being held in,
(b) a pair of elongated guiding rails (4) suitable for holding the lateral edges of the curtain, and for guiding them as the curtain is being wound or unwound about a rotating axle, X1,

characterized in that, the curtain comprises at least one resilient portion (3a) extending parallel to said lateral edges, said resilient portion being suitable for reversibly stretching along a transverse direction, normal to the longitudinal direction, from a rest configuration, L0, to a stretched configuration, L1=L0+ΔL, upon application of a pressure, P, applied substantially normal onto the surface of the curtain, and for returning substantially to its rest configuration, L0, upon release of said pressure.

### TECHNICAL FIELD

The present invention relates to fast roll-up doors comprising a curtain having lateral edges which are coupled to guiding rails for guiding the curtain during winding and unwinding thereof about a winding axle. In particular, said lateral edges are resilient to afford a reversible deformation of the curtain upon exposure to a pressure applied transverse to the plane defined by the curtain, such as wind or an impact with a vehicle or similar.

### BACKGROUND FOR THE INVENTION

There are many types of shutting systems for closing a bay, separating a room or covering a swimming pool, etc. Fast roll-up doors comprise a flexible curtain suitable for being wound or unwound about a winding axle at high speed, allowing apertures of large dimensions to be opened and shut in a very short time. They are particularly suitable for closing apertures between two rooms or between a room and the outside in warehouses, workshops, shops, laboratories, and the like. In order to ensure structural stability, the lateral edges of such curtains are coupled to guiding rails fixed to the lateral walls defining the lateral edges of the aperture. The lateral edges of the curtain can freely slide along the guiding rails during winding and unwinding but are held by the rails unless exposed to an unexpected force of sufficient magnitude to de-couple the curtain edges from their corresponding guiding rails. Some doors are provided with means for automatically driving the pulled-out curtain edge back into the rail. Such re-insertion system is disclosed e.g., in WO2008155292.

Such roll-up doors can be exposed to many aggressions, such as wind (in case they separate indoor from outdoor), accumulated rain and snow (in case the curtain is not held vertically); vehicles in movement, static obstacles placed in the closing trajectory of the curtain, and the like. Because such roll-up doors may have rather large dimensions, even a moderate pressure applied on one side of the curtain, such as by wind, can generate forces of high magnitude which are transmitted to the lateral edges of the curtain and to the coupling between lateral edges and guiding rails. As a consequence, friction between the lateral edges of the curtain and the guiding rails may be created thus hindering the winding and unwinding speed of the curtain and increasing wear rate. The guiding rails in which the lateral edges of the curtain move and are held, can be subjected to very uneven forces at one side of the curtain compared with the other side. It may even happen that all the forces thus generated are concentrated on a single side of the curtain, thus creating torsion on certain parts of said guiding rails, resulting in unpleasant appearance of crease in the curtain and in irregular wear both of the guiding rails and of the lateral edges of the curtain. Moreover, such uneven distribution of the forces increases the risk of said lateral edges suddenly coming free of the guiding rails. Even with a re-insertion system as discussed above, de-coupling of a lateral edge of a curtain is as far as possible to be avoided as it may damage it as a result.

In order to evenly distribute the forces generated by a pressure applied onto the curtain, WO9220895 proposes to elastically mount the guiding rails on static supports solidly fixed to the walls defining the lateral edges of the aperture. In a particular embodiment, the guiding rails are coupled to said static supports by means of a series of rods distributed along the length of the guiding rails, said rods being oriented normal to both guiding rails and static support, and being provided with resilient means, such as a helicoidal spring, allowing the guiding rails to reversibly separate from the static supports upon application of a given force. This solution successfully distributes the forces over the whole length of both lateral edges of the curtain and maintains the curtain under moderate tension, thus avoiding the concentration of forces at one particular area of the curtain and thus avoiding the formation of a wavy and uneven curtain surface. The installation of such system is, however, quite labour intensive, as the rods with resilient means must be mounted and calibrated individually and coupled to both guiding rails and static support. It also requires special means for sealing the space created between the static support and the guiding rails as the latter are being separated from the static support (cf. skirt (12) in FIG. 2 of WO9220895). These elements have a negative impact on the cost of the roll-up door system. Furthermore, noise is generated by the sliding of metal rods through holes in the metal static support as the springs are being strained. The noise can be reduced by using foam or elastomeric materials as illustrated in FIGS. 4 and 5 of WO9220895. Foams, however, tend to creep.

There therefore remains a need for a durable, silent, and cost effective solution for evenly distributing the forces applied onto a curtain of a roll-up door system. The present invention proposes a solution to such problem. This and other advantages of the invention are described more in detail in the following sections.

### SUMMARY OF THE INVENTION

The present invention is defined in the appended independent claims. Preferred embodiments are defined in the dependent claims. In particular, the present invention concerns a fast roll-up door for closing an aperture, said roll-up door comprising:

(a) a curtain having two opposite lateral edges extending along a longitudinal direction, and two opposite end edges joining the lateral edges, each of the two lateral edges being held in,

(b) a pair of elongated guiding rails suitable for holding the lateral edges of the curtain, and for guiding them as the curtain is being wound or unwound about a rotating axle, X1,

characterized in that, the curtain comprises at least one resilient portion (3a) extending parallel to said lateral edges, said resilient portion being suitable for reversibly stretching along a transverse direction, normal to the longitudinal direction, from a rest configuration, L1, to a stretched configuration, L1=L1+ΔL, upon application of a pressure, P, applied substantially normal onto the surface of the curtain, and for returning substantially to its rest configuration, L0, upon release of said pressure.

The expression “longitudinal direction” refers herein to the direction defined by the two parallel guiding rails. The expression “transverse direction” refers to a direction normal to the longitudinal direction and comprised within the plane defined by the curtain in its rest configuration. The two end edges of the curtain preferably extend along the transverse direction.

In a preferred embodiment, the at least one resilient portion of the curtain comprises a corrugated portion defined by ridges and valleys extending parallel to the whole length of the lateral edges, wherein two adjacent ridges of the corrugated portions at rest are separated by a rest distance, d0, and such that the distance separating two adjacent ridges of the corrugated portions increases upon application of a pressure, P, applied substantially normal onto the surface of the curtain, and returns substantially to its rest distance, d0, upon release of the force.

Alternatively or concomitantly, the at least one resilient portion can be made of an elastomeric material such as a polyurethane rubber; a silicone rubber; a thermoplastic elastomer (TPE), or other types of known elastomeric materials.

The curtain preferably comprises a central portion flanked by two lateral strips, each having a free edge forming the lateral edges of the curtain. The at least one resilient portion of the curtain is comprised within at least one of said two lateral strips (3), preferably both lateral strips comprise one such resilient portion. The lateral strips are preferably bonded to the central portion of the curtain by welding, gluing, stitching, or combinations thereof. In yet a preferred embodiment, the central portion of the curtain comprises two panes separated by a resilient strip extending along the central portion of the curtain, parallel to the whole length of the lateral edges of the curtain, said resilent strip being suitable for reversibly stretching along a transverse direction, normal to the longitudinal direction, from a rest configuration to a stretched configuration upon application of a pressure, P, applied substantially normal onto the surface of the curtain, and for returning substantially to its rest configuration upon release of said pressure.

The lateral edges of the curtain formed by the free edge of the lateral strips advantageously comprise a continuous bead or a series of discontinuous beads suitable for sliding along the guiding rails and for holding the lateral edges of the curtain in said guiding rails upon application of a force in the transverse direction which is lower than a given pull-out force, Fₚ₀. Above said pull-out force, the bead preferably pulls out of the guiding rails, so as to avoid tearing of the curtain or damages to the guiding rails.

Each resilient portion is preferably suitable for stretching by a length increase, ΔL, in a direction normal to the lateral edge upon application of a force, F, applied onto the curtain, which is comprised within the linear upper and lower boundaries defined by the relationship, F=kᵢ·L, wherein i=1 or 2, and wherein k₁=0.4 to 0.6 N/mm and k₂=0.7 to 1.0 N/mm.

In a preferred embodiment, the fast roll-up door of the present invention comprises a system for automatic re-insertion of a lateral edge of the curtain into the corresponding guiding rail in case the latter pulled out therefrom, such as if the curtain had been exposed to a force larger than the pull-out force, Fₚ₀.

The present invention also concerns a process for producing a curtain suitable for use in a fast roll-up door as defined above, said process comprising the following steps:

(a) Providing a central portion of a curtain, said central portion being flexible and comprising two parallel lateral edges,

(b) Extruding a lateral strip comprising a resilient portion, and at least one planar coupling portion;

(c) Coupling the planar coupling portion of a lateral strip as defined above to both lateral edges of the central portion of the curtain.

In a preferred embodiment, the extruded strip comprises a lateral strip comprising a free edge provided with a bead, and one planar coupling portion. The extruded strip may also be instead or additionally, a central strip comprising two planar coupling portions flanking on either side the resilient portion.

As discussed above, it is preferred that the resilient portion of the strip comprises a corrugated portion defined by ridges and valleys extending parallel to the whole length of the strip. It is also preferred that coupling a lateral strip to both lateral edges of the central portion of the curtain be carried out by welding, gluing, stitching, or combinations thereof.

Welding is preferred.

### BRIEF DESCRIPTION OF THE FIGURES

For a fuller understanding of the nature of the present invention, reference is made to the following detailed description taken in conjunction with the accompanying drawings in which:

FIG. 1: shows a general front view of a roll-up door according to the present invention.

FIG. 2: Shows a top cut-view of a door according to (a)&(b) a first embodiment and (c)&(d) a second embodiment of the present invention (a)&(c) at rest, and (b)&(d) exposed to a pressure, P.

FIG. 3: shows a first embodiment of lateral resilient portion comprising a resiliently deformable corrugated portion forming a bellow (a) at rest, and (b) exposed to a force, F.

FIG. 4: shows a second embodiment of lateral resilient portion made of a resilient material (a) at rest, and (b) exposed to a force, F.

FIG. 5: shows a typical force-deformation curve of (a) a rubber material and (b) an elastic material.

FIG. 6: shows how a curtain according to the present invention can easily be processed.

### DETAILED DESCRIPTION OF THE INVENTION

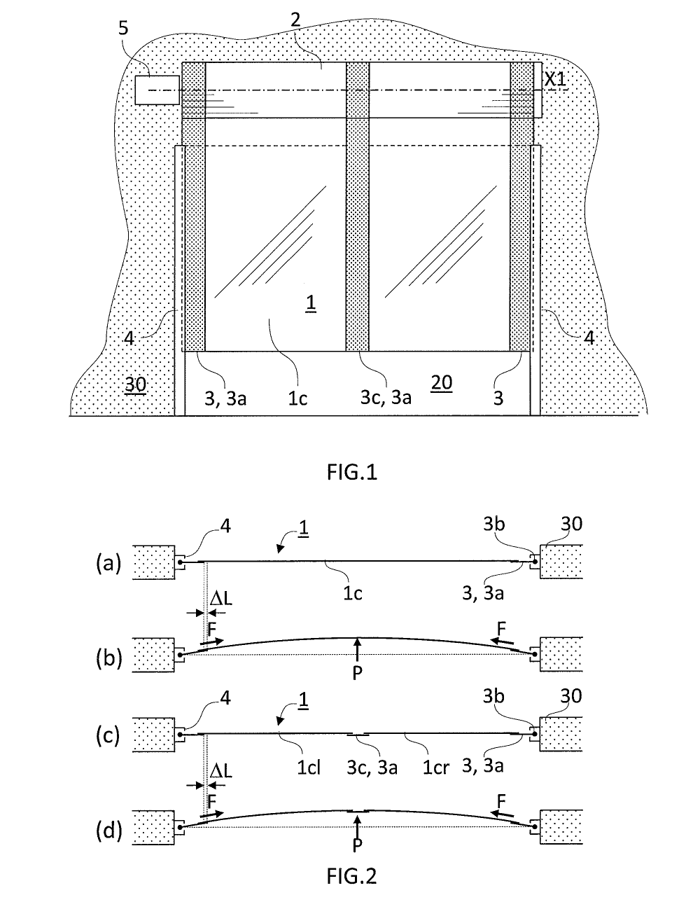

As shown in FIGS. 1 and 2, a fast roll-up door according to the present invention is useful for closing an aperture (20) which can be of large dimensions, with several meters of height and several meters of width. The roll-up door comprises a curtain (1) having two opposite and parallel lateral edges extending along a longitudinal direction, and two opposite end edges joining the two lateral edges of the curtain. Preferably, the two end edges extend along a transverse direction normal to the longitudinal direction. In a preferred embodiment the curtain therefore has a rectangular geometry, but it is possible that the end edges are not parallel, depending on curtain manufacturing tolerances. The curtain (1) is flexible and is capable of being wound about an axle, X1. By using a flexible curtain, which is light in weight with little inertia, closing and opening of the aperture can happen at high speed, of the order of 0.7 m/s and higher. The movement of the curtain is generally controlled by a motor (5) rotating the axle, Xl, to wind or unwind the curtain. The curtain is generally wound about the axle, X1, to form a drum (2), but the axle may also be used to simply change the orientation of the curtain by a given angle. In continuation, the embodiment of a drum (2) is addressed, but the teaching can apply to either embodiments.

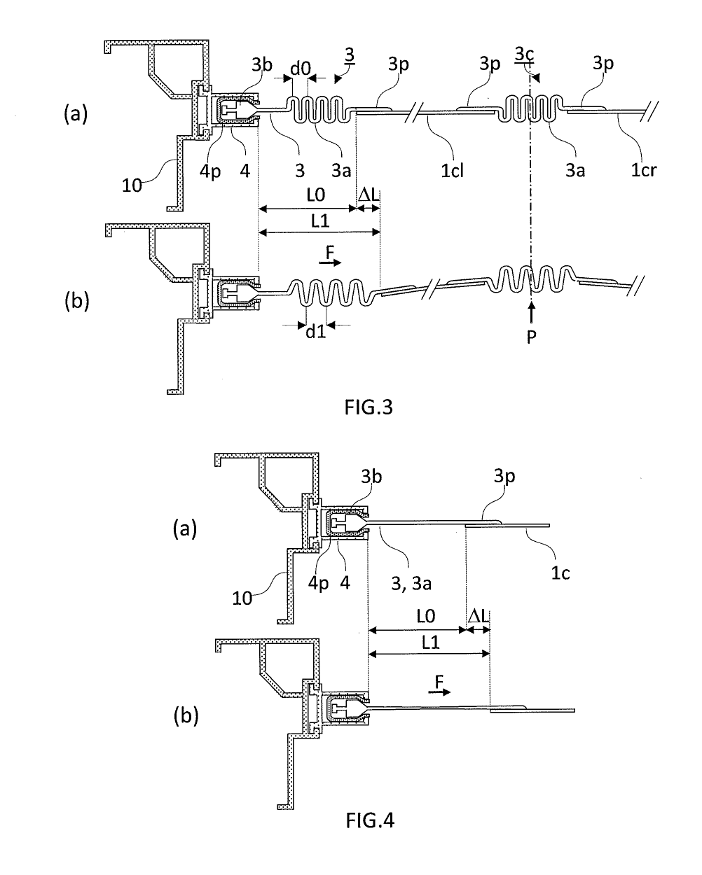

Guiding rails (4) are mounted, parallel to each other, on two opposite sides (30) of the aperture (20) with appropriate fixing means, well known to a person skilled in the art, such as profiles (10) as illustrated in FIGS. 3&4. The guiding rails (4) are suitable for, on the one hand, holding the lateral edges of the curtain (1) so as to apply a certain tension in the transverse direction to yield a smooth, wrinkleless surface and, on the other hand, for guiding the lateral edges of the curtain as it is being wound or unwound about the axle, X1.

As illustrated in FIGS. 3&4, the guiding rails preferably comprise a C-profile having a slit-shaped aperture facing towards the curtain and partially closed on either side by wings. Since the C-profiles are generally made of metal, it is advantageous to use a polymeric insert (4p) inside the guiding rail, in order to protect the lateral edges of the curtain from direct contact with possibly sharp metal edges, thus decreasing wear rate. The lateral edges of the curtain (1) are provided with a bead that can freely slid inside the volume defined by the C-profile, but cannot pull-out through the slit shaped opening of the guiding rails, unless a pull-out force, Fₚₒ, is reached. The magnitude of the pull-out force, Fₚₒ, should be sufficiently high to prevent the lateral edges of the curtain from pulling out of the guiding rails at the first stress, but sufficiently low to prevent the curtain from tearing or the guiding rails from being damaged. Such guiding rails are known in the art and are described elsewhere, such as in WO9220895 with discontinuous beads, in the form of a zip, or in WO2008/155292 disclosing a continuous bead. The latter document also discloses an automatic re-insertion device allowing the automatic re-insertion of a lateral edge of a curtain after pulling-out from a guiding rail. Such device can of course advantageously be implemented in the present invention. The disclosures of both WO9220895 and WO2008/155292 are herein included by reference. It is clear that other guiding rail/lateral edge coupling means known in the art can be used instead in the present invention as long as they allow both (a) holding the lateral edges of the curtain and (b) free sliding along the guiding rails.

As illustrated in FIG. 2(b)&(d), upon application of a pressure, P, substantially normal to the plane formed by the curtain, forces, F, are transmitted to the lateral edges of the curtain which are held in the guiding rails. Such pressure can be caused by any of a number of causes including wind blowing on the outdoor side of a curtain, an object pressing against the curtain, such as a branch, a box, a vehicle, etc., pressure difference between two rooms separated by the door, and the like. As discussed above, the forces, F, are likely to vary locally along the length of the lateral edges of the curtain, or even to be distributed unevenly from one lateral edge to the other, leading to local force concentrations which may exceed the pull-out force, Fₚₒ, and pull the curtain out of the guiding rails even for pressures, P, of moderate magnitude, which would normally not lead to a pull-out of the curtain edges. Such event is undesirable and should remain an exception in case of excess pressure, P, as every time a lateral edge is forced out of a guiding rail, the various elements of the roll-up door are severely worn. In order to evenly distribute the forces, F, caused by a pressure, P, on the curtain along the whole length of both lateral edges of the curtain, WO9220895 proposed to mount the guiding rails on a series of pins capable of reversibly moving in the transverse direction in case of a pressure being applied onto the curtain. The transverse movement of the guiding rails permits to absorb part of the local force concentrated at one portion of the lateral edges of the curtain and to distribute it along the length of the guiding rail. This system is very successful but has the drawback that its mounting is labour intensive and it can be noisy if springs are used to control the transverse movement of the pins.

A roll-up door according to the present invention takes profit of the same principle as used in WO9220895 to allow a revesible transverse movement of the curtain upon application of a pressure thereon, but instead of allowing the guiding rails to move transversally, it is a resilient portion (3a) extending parallel to and along the whole length of said lateral edges of the curtain which is suitable for reversibly stretching along the transverse direction from a rest configuration, L0, to a stretched configuration, L1=L0+ΔL, upon application of a pressure, P, applied substantially normal onto the surface of the curtain, and for returning substantially to its rest configuration, L0, upon release of said pressure. As shown in FIGS. 1, 2(c), and 3, such resilient portions (3a) can be provided adjacent to each lateral edge of the curtain and/or anywhere in a central portion of the curtain, preferably close to or at the centre thereof. While providing the same advantages as the system proposed in WO9220895, the system of the present invention is free of some of its drawbacks. Indeed, the guiding rails need only be solidly fixed to a support (30) on either side of the aperture (20) like a conventional fast roll-up door devoid of any force distributing system, and the curtain can be provided with such resilient portions (3a) in a continuous process as explained in continuation.

In a preferred embodiment illustrated in FIG. 3, the resilient portions (3a) of the curtain comprise a corrugated portion defined by ridges and valleys extending parallel to the whole length of each lateral edge. At the rest configuration, L0, two adjacent ridges of the corrugated portions are separated by a rest distance, d0 (cf. FIG. 3(a)). Upon application of a force, F, the distance separating two adjacent ridges of the corrugated portions increases to a stretched distance, d1, allowing the resilient portion to stretch by ΔL to reach its stretched configuration, L1 (cf. FIG. 3(b)). Upon release of the force, F, the distance between two adjacent ridges returns substantially to its rest distance, d0, so that the resilient portion returns to its rest configuration, L0. The crest-to-valley amplitude of a corrugation is preferably comprised between 5 and 12 mm, preferably, between 7 and 9 mm, and the rest distance, d0, between two adjacent crests is preferably comprised between between 5 and 12 mm, preferably, between 7 and 9 mm.

An additional and quite unexpected advantage of the corrugated portion (3a) is that upon winding the curtain on a drum (2), crests and valleys of the corrugated portions of one rolled layer interlock with the crests and valleys of the adjacent layers on top and below in the drum. This permits to prevent any lateral sliding of the curtain which can happen when repeatedly winding and unwinding a curtain at high speed about a drum (2). This ensures that the curtain is wound straight about the drum and does not slid sideways, thus ensuring a good winding of the curtain without folds and wrinkles that could make bad aesthetical effects and/or curtain wear.

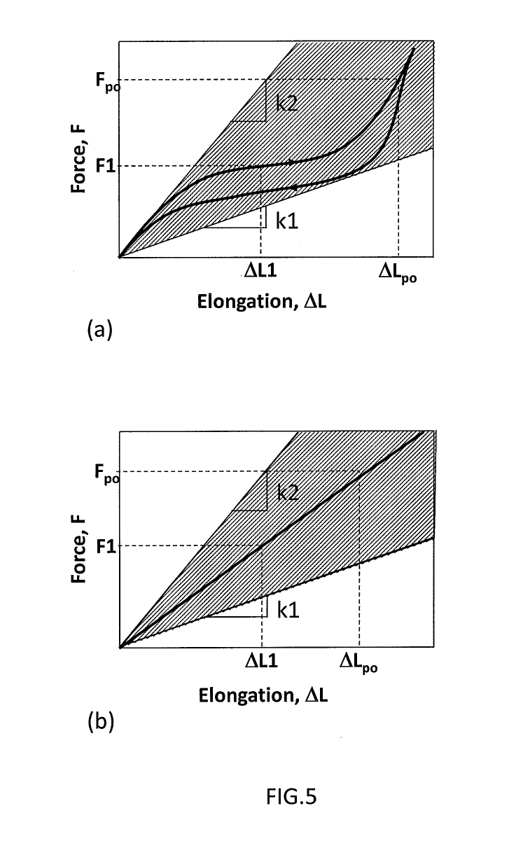

In an alternative configuration illustrated in FIG. 4, the resilient portion (3a) is made of an elastomeric material capable of stretching upon application of a force; F, from a rest configuration, L0, (cf. FIG. 4(a)) to a stretched configuration, L1, (cf. FIG. 4(b)) and of returning to its rest configuration, L0, upon release of the force, F. Rubbers and rubber like materials (i.e., having a rubber behaviour as illustrated in FIG. 5(a)) are preferred in this embodiment. For example, the resilient portion (3a) can be made of one of a polyurethane rubber; a silicone rubber; a thermoplastic elastomer (TPE) such as ethylene-vinyl acetate (EVA), ethylene propylene rubber (EPM), ethylene propylene diene rubber (EPDM); a natural or synthetic polyisoprene; a polybutadiene; a chloroprene rubber, such as polychloroprene, neoprene, baypren; a butyl rubber (copolymer of isobutylene and isoprene); a halogenated butyl rubber such as chloro butyl rubber; bromo butyl rubber; a styrene-butadiene rubber (copolymer of styrene and butadiene), nitrile rubber (copolymer of butadiene and acrylonitrile). Polyurethane rubbers and thermoplastic elastomers (TPE) are particularly preferred.

It is clear that both embodiments illustrated in FIGS. 3&4 and discussed above can advantageously be combined, yielding a resilient portion (3a) comprising a corrugated portion made of an elastomeric material.

The resilient portion (3a) must be able upon application of a transverse force, F, to the curtain to stretch from a rest configuration, L0, to a stretched configuration, L1, and return to its rest configuration, L0, upon release of the force. The reversibility of the stretch behaviour of the resilient portion (3a) of the curtain can span anything between and including an elastic behaviour as illustrated with a thick solid line in FIG. 5(b), and a rubber behaviour as illustrated with a thick solid line in FIG. 5(a), showing a hysteresis between the force-elongation loading and unloading curves (cf. arrows in FIG. 5(a)). Each resilient portion (3a) of the curtain (1) is preferably suitable for stretching by a length increase, ΔL, in a direction normal to the lateral edge upon application of a force, F, applied onto the curtain, which is comprised within the linear upper and lower boundaries illustrated as a shaded area between the two thin solid boundary straight lines in FIG. 5(a)&(b) and defined by the relationship, F=kᵢ ΔL, wherein i=1 or 2, and wherein k₁=0.4 to 0.6 N/mm and k₂=0.7 to 1.0 N/mm. As shown in FIG. 5. Upon application of a force, F1, onto the curtain in a direction normal to the lateral edges thereof, the resilient portion stretches by a length increase, ΔL1. Upon application of a force, F2, the resilient portion stretches by a length increase, ΔL2. and so on, until a pull-out force, Fₚₒ, is applied, which is sufficient for the pulling out of a lateral edge of a curtain from a guiding rail and corresponding to a deformation, ΔLₚₒ, which is preferably still within the reversible part of the force-deformation curve characterizing it. Else, the resilient portion would be plastically deformed and/or would lose part of its resiliency after re-insertion of the curtain lateral edge into the corresponding guiding rail.

In a preferred embodiment, the curtain comprises a central portion (1c) flanked by two lateral strips (3), each having a free edge forming the lateral edges of the curtain. The resilient portions (3a) of the curtain are comprised within said two lateral strips (3). The central portion (1c) of the curtain can be made of any material traditionally used for such purpose, such as fabric of polyester or aramid fibres impregnated with a polymer such as PVC, polyurethane, silicone, yielding good mechanical stability and imperviousness to fluids, such as rain, wind, and the like. As illustrated in FIGS. 3&4, the lateral strips (3) can be made of a polymer, rubbery or not, depending on whether the strips comprise a corrugated portion. They are advantageously produced by extrusion comprising:

a planar coupling portion (3p) for coupling the strip to the central portion (1c) of the curtain;

if it applies, a corrugated portion (3a);

and preferably a bead (3b) continuous or discontinuous, and suitable for engaging in a sliding relationship inside a C-profile forming the guiding rail (4) and for disengaging upon application of a transverse pull-out force, Fₚₒ.

The planar coupling portion (3p) of the lateral strips (3) may be coupled to the central portion (1c) of the curtain by welding, gluing, stitching, or combinations thereof. By this means, the curtain (1) can be produced in a continuous process, which is not restricted by the size of the curtain, and very simple to mount on an aperture (20), by simply solidly fixing the guiding rails (4) to lateral supports (30) flanking either sides of the aperture. No particular calibration of any springs or other features is required for the resilient portion to function as desired.

In yet a preferred embodiment illustrated in FIGS. 2(c)&(d) and 3, the central portion (1c) of the curtain (1) comprises two panes (1cr, 1cl) separated by a central strip (3c) extending along the central portion (1c) of the curtain, parallel to the whole length of the lateral edges of the curtain and comprising a resilient portion (3d). Like the lateral strips (3), said central strip (3c) is suitable for reversibly stretching along a transverse direction, normal to the longitudinal direction, from a rest configuration to a stretched configuration upon application of a pressure, P, applied substantially normal onto the surface of the curtain, and for returning substantially to its rest configuration upon release of said pressure. The central strip (3c) comprises a resilient portion (3d) flanked on either sides by a planar coupling portion for coupling the central resilient strip (3c) to each pane (1cr, 1cl) of the central portion (1c) of the curtain. As for the lateral strips (3), the resilient portion (3d) of the central strip (3c) may consist of a corrugated portion and/or may be made of an elastomeric material as discussed above with reference to the lateral strips. A first advantage of a central strip (3c) is that a given elongation of the curtain (1) may be obtained with a lower stretching of each resilient strip, thus enlarging the choice of candidate materials for the lateral and central strips. Indeed, the stretching required by each resilient strip to yield a given elongation of the curtain is inversely proportional to the number, N, of resilient strips present in the curtain, wherein N=1, in case only one lateral strip (3) comprises a resilient portion (3a), N=2, in case both lateral strips (3) comprises a resilient portion (3a), N=3, if the curtain further comprises a central strip (3c), and N>3 if the curtain comprises more than one central strip (3c). The specific case of two lateral strips and one or more central strips comprising a corrugated portion (3d), yields the further advantage that as the curtain is being wound on the drum rotating about the axle, X1, the respective corrugations of each strip between overlying layers in the drum match to maintain a given distance between layers yielding an aesthetically pleasing appearance, without wrinkles or sagging. As discussed above, the interlocking between the corrugated portions of one layer and the one of the adjacent layers stabilizes the drum laterally.

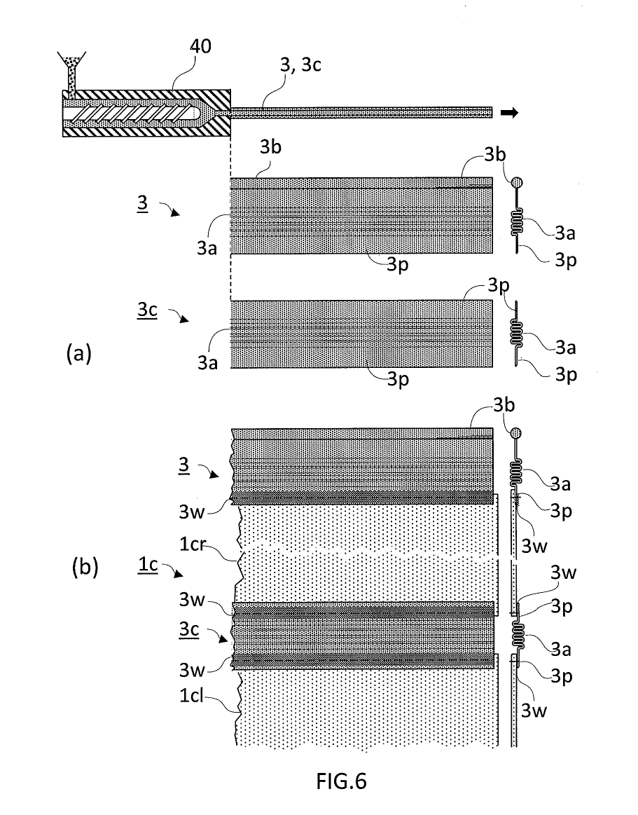

The manufacturing of a curtain (1) for a fast roll-up door according to the present invention is very simple and economical. As illustrated in FIG. 6, the process for manufacturing such curtain comprises:

(a) Providing a central portion (1c, 1cr, 1cl) of a curtain (1), said central portion (1c) being flexible and comprising two parallel lateral edges (cf. FIG. 6(a)),
(b) Extruding (40) a strip (3, 3c) comprising a resilient portion (3a), and at least one planar coupling portion (3p);
(c) Coupling the at least one planar coupling portion (3p) of said extruded strip (3, 3c) to the central portion (1c) of the curtain (cf. FIG. 6(b)).

The extruded strip can be a lateral strip (3) comprising a free edge provided with a bead (3b), and one planar coupling portion (3p); The extruded strip can be a central strip (3c) comprising two planar coupling portions (3p) flanking on either side the resilient portion (3a); As shown in FIG. 6(b), the extruded strips (3, 3c) can be coupled to the central portion (1c) of the curtain by welding, gluing, and/or stitching the respective planar coupling portions (3p) of the strips to the lateral edges of the central portion of the curtain (1c, 1cr, 1cl). As illustrated in FIG. 6, the curtain may comprise both extruded lateral strips (3) and extruded central strip (3c). Alternatively it may comprise only one or two lateral strips (3) with a resilient portion (3a) or only one or more central strips (3c) with a resilient portion (3a).

The fast roll-up door of the present invention therefore provides all the advantages of even force distribution along the whole length of both lateral edges of a curtain as described in WO9220895 but at a lower cost, because the curtain can be provided with the resilient portions (3a) discussed above in plant and with a fully automated process.

Installation of a roll-up door according to the present invention is therefore exactly the same as for a state of the art roll-up door devoid of any force distributing system.

1. A fast roll-up door for closing an aperture (20), said roll-up door comprising:
(a) a curtain (1) having two opposite and parallel lateral edges extending along a longitudinal direction, and two opposite end edges joining the lateral edges, each of the two lateral edges being held in,
(b) a pair of elongated guiding rails (4) suitable for holding the lateral edges of the curtain, and for guiding them as the curtain is being wound or unwound about a rotating axle, X1,
characterized in that, the curtain comprises at least one resilient portion (3a) extending parallel to said lateral edges, said resilient portion being suitable for reversibly stretching along a transverse direction, normal to the longitudinal direction, from a rest configuration, L0, to a stretched configuration, L1=L0+ΔL, upon application of a pressure, P, applied substantially normal onto the surface of the curtain, and for returning substantially to its rest configuration, L0, upon release of said pressure.

2. Fast roll-up door according to claim 1, wherein the at least one resilient portion (3a) of the curtain comprises a corrugated portion defined by ridges and valleys extending parallel to the whole length of the lateral edges, wherein two adjacent ridges of the corrugated portions at rest are separated by a rest distance, d0, and such that the distance separating two adjacent ridges of the corrugated portions increases upon application of a pressure, P, applied substantially normal onto the surface of the curtain, and returns substantially to its rest distance, d0, upon release of the force.

3. Fast roll-up door according to claim 1, wherein the at least one resilient portion (3a) is made of an elastomeric material selected from a polyurethane rubber; a silicone rubber; a thermoplastic elastomer (TPE) such as ethylene-vinyl acetate (EVA), ethylene propylene rubber (EPM), ethylene propylene diene rubber (EPDM); a natural or synthetic polyisoprene; a polybutadiene; a chloroprene rubber, such as polychloroprene, neoprene, baypren; a butyl rubber (copolymer of isobutylene and isoprene); a halogenated butyl rubber such as chloro butyl rubber; bromo butyl rubber; a styrene-butadiene rubber (copolymer of styrene and butadiene), nitrile rubber (copolymer of butadiene and acrylonitrile).

4. Fast roll-up door according to claim 1, wherein the curtain comprises a central portion (1c) flanked by two lateral strips (3), each having a free edge forming the lateral edges of the curtain, the at least one resilient portion (3a) of the curtain being comprised within at least one of said two lateral strips (3), preferably both lateral strips (3) comprise one such resilient portion (3a).

5. Fast roll-up door according to claim 4, wherein the lateral edges of the curtain formed by the free edge of the lateral strips (3) comprise a continuous bead (3b) or a series of discontinuous beads (3b) suitable for sliding along the guiding rails and for holding the lateral edges of the curtain in said guiding rails upon application of a force in the transverse direction which is lower than a given pull-out force, Fₚₒ.

6. Fast roll-up door according to claim 4, wherein the central portion (1c) of the curtain (1) comprises two panes (1cr, 1cl) separated by a resilient strip (3c) comprising said at least one resilient portion (3a) extending along the central portion (1c) of the curtain, parallel to the whole length of the lateral edges of the curtain,.

7. Fast roll-up door according to claim 4, wherein each resilient portion (3a) is suitable for stretching by a length increase, ΔL, in a direction normal to the lateral edge upon application of a force, F, applied onto the curtain, which is comprised within the linear upper and lower boundaries defined by the relationship, F=k₁ ΔL, wherein i=1 or 2, and wherein k₁=0.4 to 0.6 N/mm and k₂=0.7 to 1.0 N/mm.

8. Fast roll-up door according to claim 4, wherein the lateral strips (3) and/or the resilient strip (3c) are bonded to the central portion (1c, 1cr, 1cl) of the curtain by welding, gluing, stitching, or combinations thereof.

9. Fast roll-up door according to claim 1, comprising a system for automatic re-insertion of a lateral edge of the curtain into the corresponding guiding rail (4), in case the latter pulled out therefrom.

10. Process for producing a curtain (1) suitable for use in a fast roll-up door according to claim 4, said process comprising the following steps:
(a) Providing a central portion (1c) of a curtain (1), said central portion (1c) being flexible and comprising two parallel lateral edges,
(b) Extruding a strip (3, 3c) comprising a resilient portion (3a), and at least one planar coupling portion (3p);
(c) Coupling the at least one planar coupling portion (3p) of said extruded strip to (3, 3c) the central portion (1c) of the curtain.

11. Process according to claim 10, wherein the extruded strip comprises a lateral strip (3) comprising a free edge provided with a bead (3b), and one planar coupling portion (3p).

12. Process according to claim 10, wherein the extruded strip comprises a central strip (3c) comprising two planar coupling portions (3p) flanking on either side the resilient portion (3a);

13. Process according to claim 10, wherein the resilient portion (3a) of the strip (3, 3c) comprises a corrugated portion defined by ridges and valleys extending parallel to the whole length of the strip.

14. Process according to claim 10, wherein coupling a strip (3, 3c) to the central portion (1c) of the curtain is carried out by welding, gluing, stitching, or combinations thereof.
